(19) United States
(12) Patent Application Publication
(10) Pub. No.: US 2005/0141852 A1
(43) Pub. Date: Jun. 30, 2005

(54) Recording/reproducing apparatus

(75) Inventors: Shiro Nagaoka, Ome-shi (JP); Tatsuhiko Ikehata, Ome-shi (JP); Kei Tashiro, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 10/979,264

(22) Filed: Nov. 3, 2004

(30) Foreign Application Priority Data
Dec. 25, 2003 (JP) 2003-431454

(51) Int. Cl. H04N 5/76; H04N 5/225

(52) U.S. Cl. 386/46; 386/117

(57) ABSTRACT

When a user operates an operation section to start motion video imaging, a CPU records a start position in a file header part in a memory medium and records motion video data in the memory medium. At predetermined time intervals, the CPU records an end position in the header part and creates a single division file. Subsequently, the CPU records a start position in the header part in the memory medium and records continuously imaged motion video data in the memory medium. If the user operates the operation section to stop the motion video imaging, the CPU records an end position in the header part of the last division file in the entire file. Thus, the CPU stores the entire file as a single file comprising a plurality of division files.

### CROSS-REFERENCE TO RELATED APPLICATIONS

This application is based upon and claims the benefit of priority from prior Japanese Patent Application No. 2003-431454, filed Dec. 25, 2003, the entire contents of which are incorporated herein by reference.

### BACKGROUND OF THE INVENTION

1. Field of the Invention

The present invention relates to a recording/reproducing apparatus for a digital signal, which has functions of recording, storing and reproducing motion video.

2. Description of the Related Art

There have been an increasing number of digital still cameras in the prior art, which can take not only still images but also motion video (e.g. Jpn. Pat. Appln. KOKAI Publication No. 2002-142145).

Motion video is recorded and stored as a large single file. This is a very general idea, and motion video that is taken by a single imaging operation is stored as a single file. To recognize such a single file as an object of reproduction is intuitive and easy to understand.

At present, however, memory media such as hard disk drives and nonvolatile EEPROMs, which have personal-computer-based file management architectures, have gradually become common. In this situation, the means based on a single-file concept may involve some danger.

In the case where motion video data is recorded with the personal-computer-based file management architecture, if write of motion video data is actually started, a header of an associated file is first recorded at the beginning portion of the motion video data. The header includes information indicative of the location of the motion video data. Hence, when the imaging of motion video data is completed, it is necessary to refer back to the header of the file and to describe, in the header, information indicative of a point up to which the motion video data is present. After executing this work, the motion video data is first recognized as a single file.

The single-file storing method, as mentioned above, is intuitive and easy to understand from the standpoint of file management.

However, the imaging of motion video takes a long time. If the motion video imaging is forcibly interrupted by an accident such as removal of the battery due to a shock, all the acquired motion video data would be lost. Such an accident can be prevented to some extent by some means on the casing side, but it is difficult to completely deal with it. In particular, the frequency of occurrence of such accidents is high in the case of digital still cameras and digital video cameras that are designed for portable use.

### BRIEF SUMMARY OF THE INVENTION

The object of an aspect of the present invention is to provide a recording/reproducing apparatus that can minimize loss of motion video data even where imaging of motion video is interrupted by an accident, etc.

According to an aspect of the present invention, there is provided a recording/reproducing apparatus comprising: imaging means for executing imaging by converting an optical image to an electrical signal; a memory medium for storing motion video data that is acquired by the imaging means; first control means for executing, when imaging by the imaging means is started, a control to divide the motion video data at predetermined time intervals and to record a plurality of divided motion video data in the memory medium; and second control means for executing, when the imaging by the imaging means is stopped, a control to store the plurality of divided motion video data, which are dividedly recorded in the memory medium under the control of the first control means, as single motion video data in the memory medium.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram that schematically shows the structure of a recording/reproducing apparatus according to the present invention;

FIG. 2 shows an example of recording in the case where motion video is imaged by a prior-art recording/reproducing apparatus;

FIG. 3 shows an example of recording in the case where motion video is imaged by the prior-art recording/reproducing apparatus;

FIG. 4 shows an example of recording in the case where motion video is imaged by the prior-art recording/reproducing apparatus;

FIG. 5 shows an example of recording in the case where motion video is imaged by the prior-art recording/reproducing apparatus;

FIG. 6 shows an example of recording in the case where motion video is imaged by the prior-art recording/reproducing apparatus;

FIG. 7 is a flow chart illustrating a motion video imaging operation of the recording/reproducing apparatus according to the invention;

FIG. 8 illustrates write of a start position in a header (indicated by a meshed area);

FIG. 9 illustrates write of motion video data (indicated by a hatched area);

FIG. 10 illustrates write of an end position in the header (indicated by horizontal lines);

FIG. 11 indicates header parts and motion video data parts, of which division files are formed;

FIG. 12 shows a state in which a single file is composed of five division files;

FIG. 13 shows a state of a memory medium in the case where an imaging operation is forcibly interrupted in the prior art;

FIG. 14 shows a state of a memory medium in the case where an imaging operation is forcibly interrupted in the prior art;

FIG. 15 shows a state of a memory medium in the case where an imaging operation is forcibly interrupted in the recording/reproducing apparatus of the present invention; and

FIG. 16 shows a state of a memory medium in the case where an imaging operation is forcibly interrupted in the recording/reproducing apparatus of the present invention.

### DETAILED DESCRIPTION OF THE INVENTION

An embodiment of the present invention will now be described in detail with reference to the accompanying drawings.

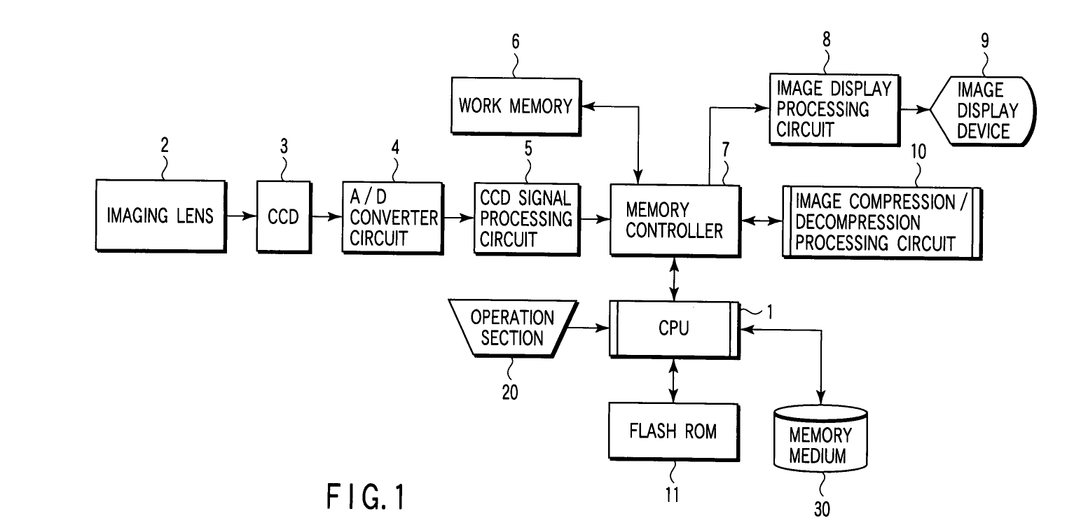

FIG. 1 schematically shows the structure of a recording/reproducing apparatus according to the present invention. Specifically, the recording/reproducing apparatus comprises a CPU 1 for an overall control; an imaging lens 2; a CCD (Charge-Coupled Device) 3; an A/D converter circuit 4 for converting an analog signal to a digital signal; a CCD signal processing circuit 5 for processing a digital signal; a work memory 6 for temporarily storing a process signal, etc.; a memory controller 7 for controlling the work memory 6, etc.; an image display device 9 that displays an image delivered from an image display processing circuit 8; and an image compression/decompression processing circuit 10 that performs a compression/decompression process for a digital signal. The CPU 1 has a flash ROM 11 that temporarily stores various parameters.

The CPU 1 is connected to an operation section 20 and a memory medium 30 such as a memory card.

The operation section 20 is provided with operation buttons including a menu key, a cross (+) key and a shutter button, and executes various operations.

The memory medium 30 is configured to be attachable/detachable. A video signal (compressed digital signal) is transferred and recorded in the memory medium 30.

In order to describe the present invention, a prior-art motion video recording system is first described.

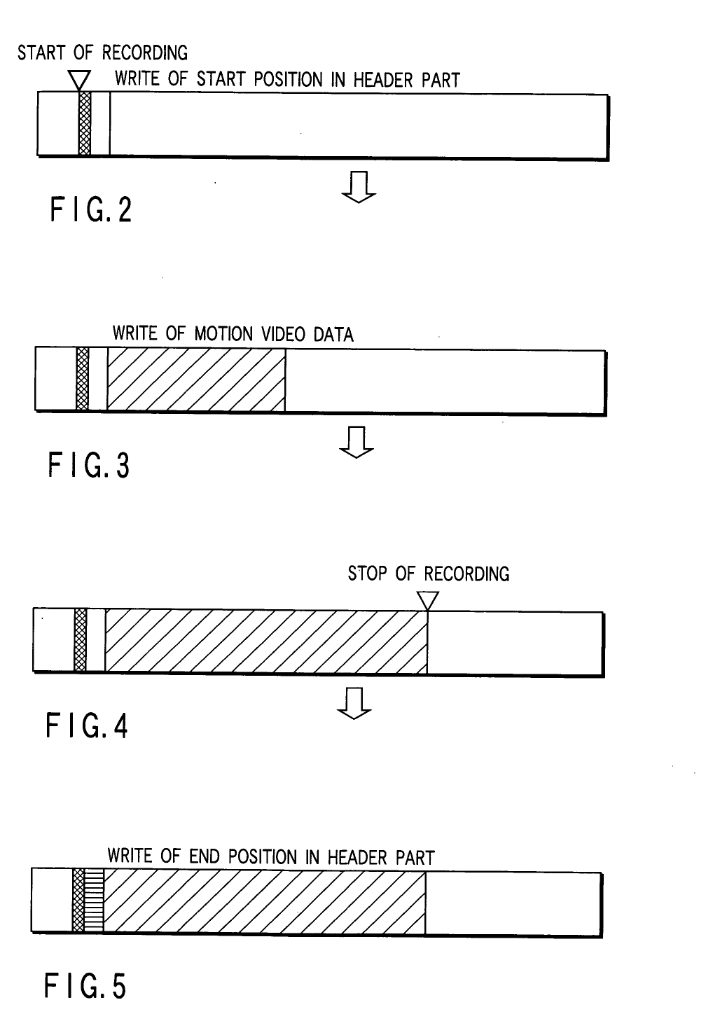

FIGS. 2 to 6 show an example of recording in the case where motion video is imaged with a prior-art recording/reproducing apparatus.

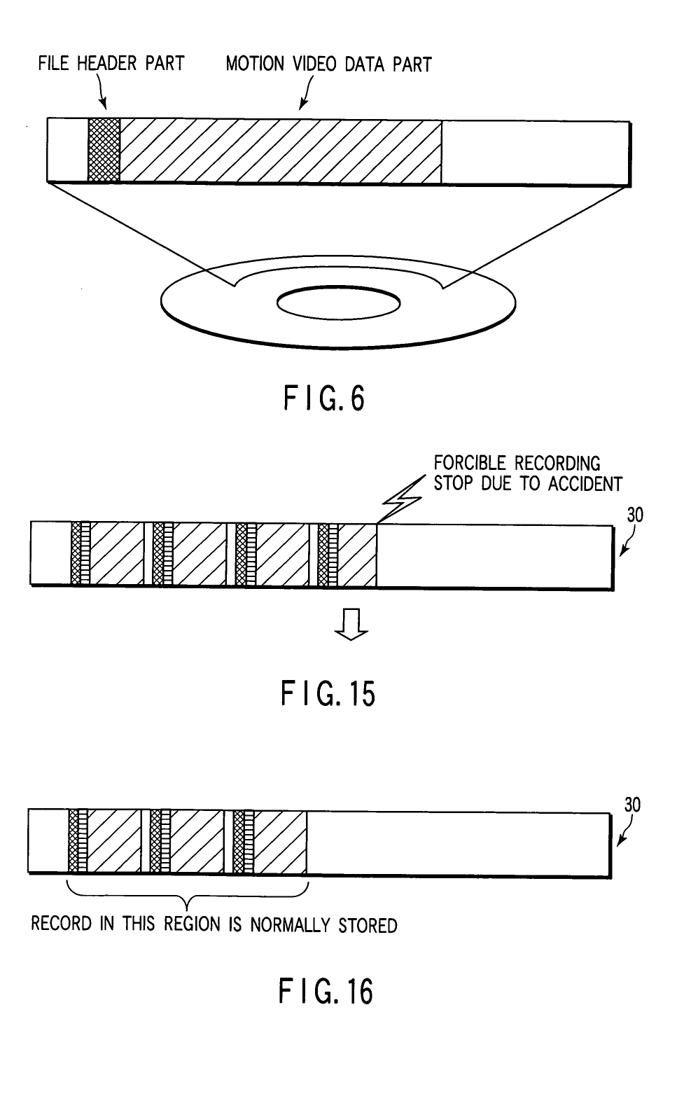

When motion video imaging is started by the user's operation, a start position (indicated by a meshed area) is recorded in a file header part, as shown in FIG. 2. Then, as shown in FIG. 3, actually imaged motion video data is recorded (indicated by hatching). When the imaging is stopped by the user's operation as shown in FIG. 4, an end position (indicated by horizontal lines) is recorded in the file header part, as shown in FIG. 5. Thus, a single file comprising the file header part and motion image data part is completed, as shown in FIG. 6.

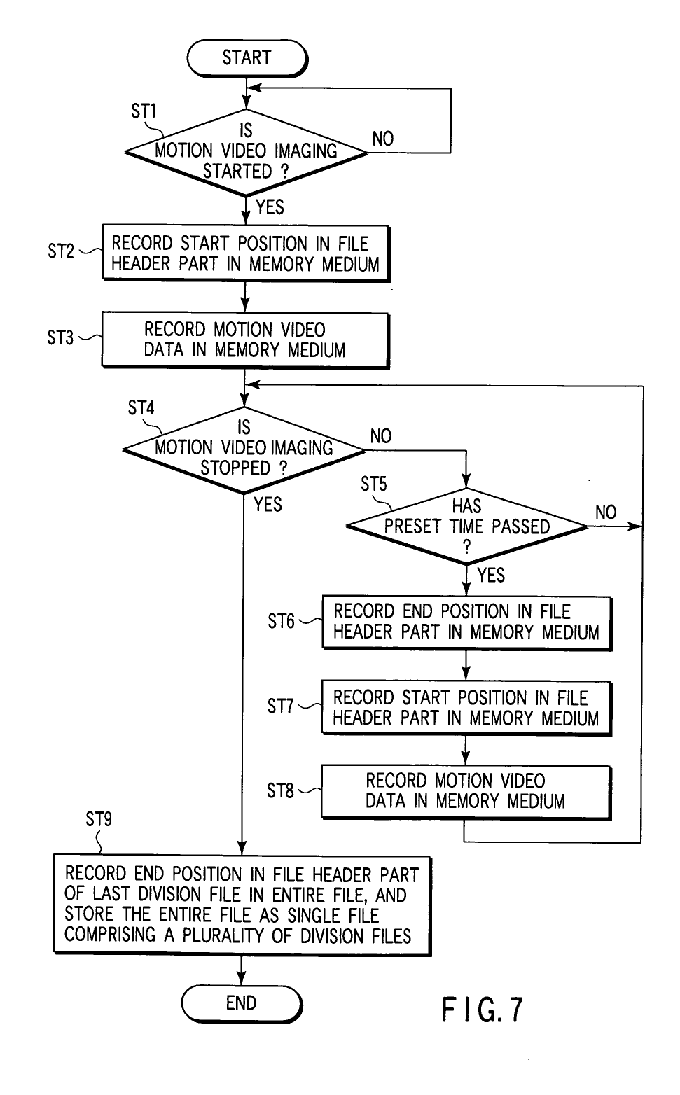

Next, a motion video imaging operation of the recording/reproducing apparatus with the structure shown in FIG. 1 will now be described with reference to a flow chart of FIG. 7.

When the user operates the operation section 11 to start the motion video imaging (ST1), the CPU 1 records a start position in a file header part (hereinafter referred to as “header part”) in the memory medium 30 (ST2).

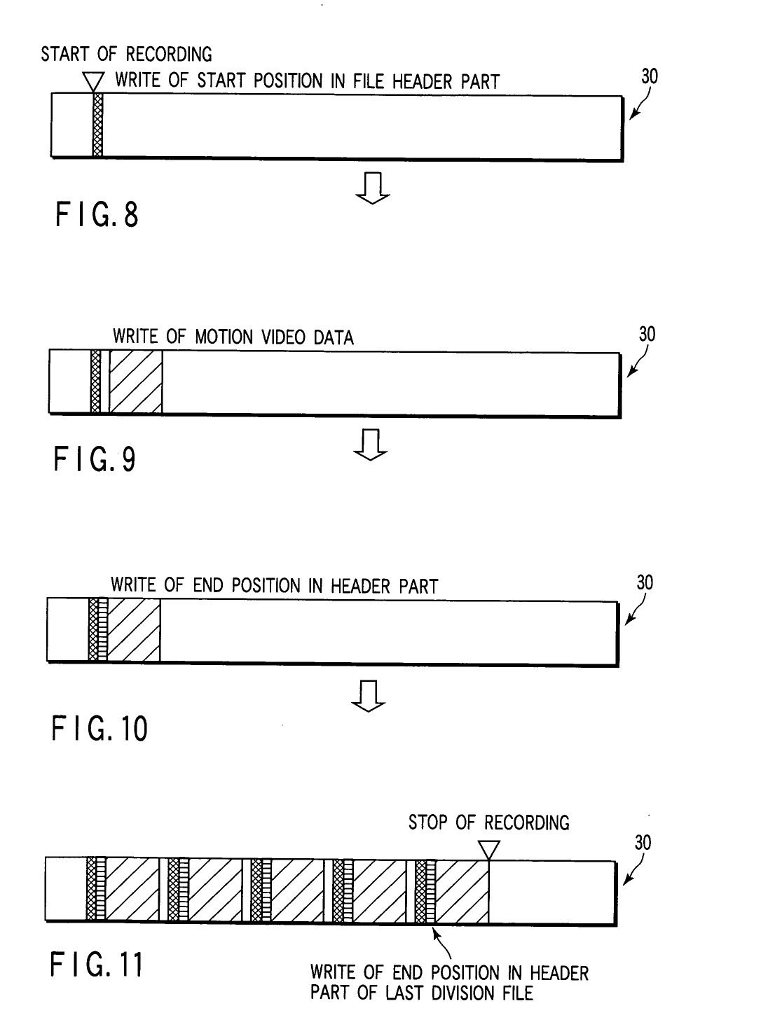

FIG. 8 illustrates write of the start position in the header part (as indicated by a meshed area).

Subsequently, the CPU 1 records actually imaged motion video data in the memory medium 30 (ST3).

FIG. 9 illustrates write of motion video data (as indicated by a hatched area).

If the motion video imaging is continued (ST4) and a preset time has passed (ST5), the CPU 1 records an end position in the header part and creates a single division file (ST6).

FIG. 10 illustrates write of the end position in the header part (as indicated by horizontal lines).

Then, the CPU 1 records a start position in the header part in the memory medium 30 (ST7) and records continuously imaged motion video data in the memory medium 30 (ST8).

FIG. 11 shows header parts and motion video data parts, of which division files are formed.

In step ST4, if the user operates the operation section 11 to stop the motion video imaging, the CPU 1 records an end position in the header part of the last division file in the entire file. Thus, the CPU 1 stores the entire file as a single file comprising a plurality of division files (ST9).

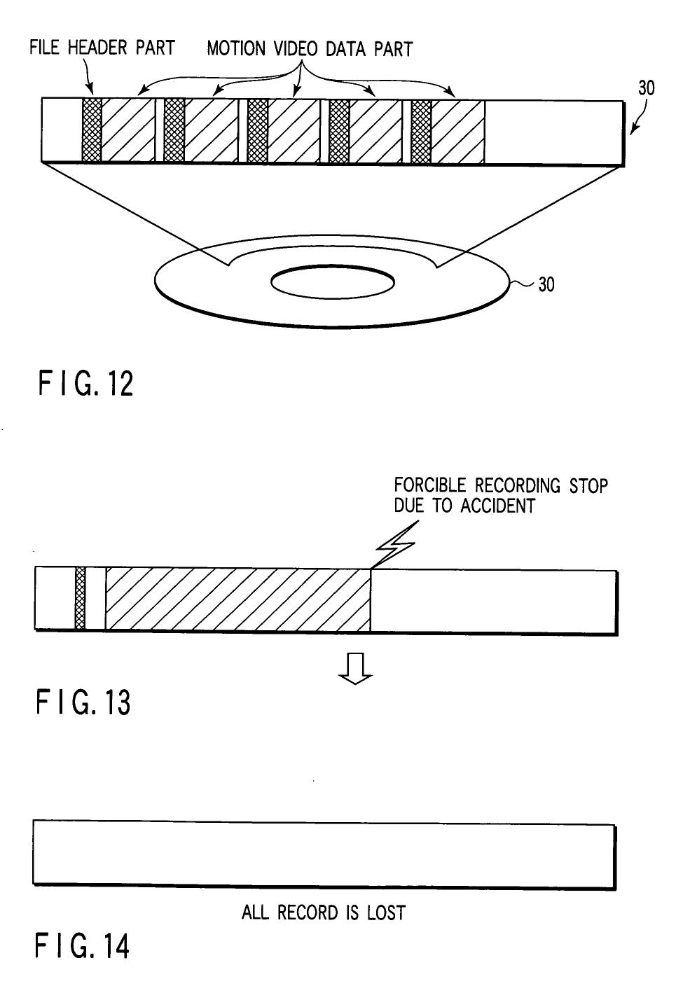

FIG. 12 illustrates an example of storage of the above-mentioned single file, which comprises five division files. At a time of reproduction, the CPU 1 reproduces the five division files as a single file.

FIGS. 13 and 14 show states of a memory medium in a case where an imaging operation is forcibly interrupted by an accident or the like in the prior art. In the prior art, when the recording operation is forcibly stopped by an accident, as shown in FIG. 13, all the recorded data would be lost, as shown in FIG. 14.

FIGS. 15 and 16 show states of a memory medium in a case where an imaging operation is forcibly interrupted by an accident or the like in the recording/reproducing apparatus according to the present invention. In this recording/reproducing apparatus, the last division file, which is not formed as a complete file, is lost, but the preceding division files are normally stored. Therefore, the data, which has been recorded up to a certain point of time before the interruption, is not lost.

When division files are to be formed as a single file, such a single file may be recorded in the header part. Alternatively, division files in a single folder in the memory hierarchy structure in the memory medium 30 may be formed as a single file.

When a single file comprising a plurality of division files is to be reproduced, these division files may be synthesized and reproduced. In this case, the division files are reproduced as a complete single file from the next time.

When motion video data is transferred from the present recording/reproducing apparatus to a personal computer, it is possible to indicate that the division files are a single file or the division files are a single folder. Thereby, the transfer destination can reproduce the division files, recognizing that the division files are a single file or a single folder.

In addition, the personal computer may integrate the division files within the single file or the single folder, reconstruct the division format, and re-store and record the integrated file.

Besides, in the case where a single file comprising a plurality of division files is reproduced, the beginning part of each division file may be used as a marker, whereby high-speed start-point finding can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A recording/reproducing apparatus comprising:
imaging means for executing imaging by converting an optical image to an electrical signal;
a memory medium for storing motion video data that is acquired by the imaging means;
first control means for executing, when imaging by the imaging means is started, a control to divide the motion video data at predetermined time intervals and to record a plurality of divided motion video data in the memory medium; and
second control means for executing, when the imaging by the imaging means is stopped, a control to store said plurality of divided motion video data, which are dividedly recorded in the memory medium under the control of the first control means, as single motion video data in the memory medium.

2. The recording/reproducing apparatus according to claim 1, further comprising reproduction means for reproducing, when said single motion video data comprising said plurality of divided motion video data is to be reproduced, the motion video data as the single motion video data.

3. The recording/reproducing apparatus according to claim 1, further comprising synthesizing means for synthesizing, when said single motion video data comprising said plurality of divided motion video data is to be reproduced, the motion video data as the single motion video data.

4. The recording/reproducing apparatus according to claim 1, wherein said first control means controls said dividing on the basis of a preset time in units of a minute or a second.

5. The recording/reproducing apparatus according to claim 1, wherein said predetermined time intervals are preset by setting means that is included in the recording/reproducing apparatus.

6. The recording/reproducing apparatus according to claim 1, further comprising means for storing and managing said plurality of divided motion video data by putting said plurality of divided motion video data together into a file or a folder, and handling said plurality of divided motion video data as single motion video data in units of a file or a folder.

7. The recording/reproducing apparatus according to claim 1, further comprising transfer means for transferring said single motion video data as a single motion video data file, when said single motion video data, which is stored in the memory medium such that said plurality of divided motion video data are recorded as single motion video data in the memory medium, is to be transferred.
